(19) United States
(12) Patent Application Publication
(10) Pub. No.: US 2023/0026302 A1
(43) Pub. Date: Jan. 26, 2023

(54) BATTERY PACK VENTING

(71) Applicant: Rivian IP Holdings, LLC, Plymouth, MI (US)

(72) Inventors: Daniel Alfredo Hernandez Saab, Irvine, CA (US); Kyle Butterfield, Rancho Santa Margarita, CA (US)

(21) Appl. No.: 17/380,344

(22) Filed: Jul. 20, 2021

(51) Int. Cl. H01M 50/325

(52) U.S. Cl. CPC H01M 50/325; H01M 2220/20

(57) ABSTRACT

Systems are presented herein for venting pressure and heat from a battery pack. The system may include a set of walls encompassing a plurality of battery cells. Embedded in the walls may be a plurality of venting structures, which may be configured to release pressure and/or temperature building within the battery pack. The plurality of venting structures may include a plurality of valves, including a fixed valve configured to vent at a first flow rate, and a movable valve configured to vent at a second flow rate exceeding the first flow rate. The plurality of venting structures may also include a deformable vent structure configured to physically deform to provide a third flow rate exceeding the second flow rate.

### INTRODUCTION

The present disclosure is directed to systems for venting pressure and heat from a battery pack, and more particularly, to assemblies that enable venting of pressure and/or heat from a battery pack while restricting or preventing fluid ingress to the battery pack.

### SUMMARY

In at least some example illustrations, a battery pack is provided comprising one or more battery cells and one or a plurality of walls defining at least in part an enclosure for the battery cells. The enclosure is substantially sealed, such that a temperature increase causes excess pressure within the enclosure. The pack also includes one or a plurality of vents embedded in the plurality of walls, each of which is configured to vent from the enclosure to reduce the excess pressure. The plurality of vents may comprise at least one or a plurality of valves, including a vent plug valve configured to vent from the enclosure at a first flow rate, and an umbrella valve configured to vent from the enclosure through the umbrella valve at a second flow rate greater than the first flow rate. The pack may also include a deformable vent structure configured to physically deform to permit a third flow rate through the deformable vent structure, the third flow rate greater than the second flow rate.

In at least some example illustrations, a vehicle system may include a vehicle body and a plurality of battery packs mounted inside the vehicle body. The battery packs may include one or more battery cells and one or more walls as described above. The battery packs may comprise a plurality of walls defining at least in part an enclosure for the plurality of battery cells. The enclosure may be substantially sealed such that a thermal expansion causes excess pressure within the enclosure. The battery pack may include a plurality of venting structures embedded in the plurality of walls, with each of the plurality of venting structures is configured to vent the excess pressure. The plurality of venting structures may include a plurality of valves including a fixed position valve configured to vent from the enclosure through the fixed position valve at a first flow rate, and an umbrella valve configured to vent from the enclosure at a second flow rate greater than the first flow rate. The plurality of venting structures may also include a deformable vent configured to permit a third flow rate greater than the second flow rate to vent heat from inside the enclosure through the deformable vent.

In at least some examples, a method of venting a battery assembly or pack includes arranging a plurality of battery cells to provide electricity to a vehicle, and enclosing the plurality of battery cells with a plurality of walls. The plurality of walls may be substantially sealed such that a temperature increase causes excess pressure within an enclosure. The method may further include embedding a plurality of venting structures in the plurality of walls. Each of the plurality of venting structures may be configured to vent from the enclosure to reduce the excess pressure. The plurality of venting structures may include one or more valves, including a first valve configured to vent from the enclosure through the first venting structure at a first flow rate, and a second valve structure configured to vent from the enclosure through the second venting structure at a second flow rate greater than the first flow rate. The plurality of venting structures may further include a deformable venting structure configured to physically deform to vent from the enclosure through the deformable structure at a third flow rate greater than the second flow rate.

### BRIEF DESCRIPTIONS OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale. The above and other objects and advantages of the disclosure may be apparent upon consideration of the following detailed description, taken in conjunction with the accompanying drawings, in which:

FIG. 1 illustrates a top view of a battery pack or assembly configured with a plurality of venting structures in the walls of the battery pack, accordance with some embodiments of the present disclosure;

FIG. 2 illustrates a cross-sectional view of a first venting structure, which is a vent plug valve configured to vent at a first flow rate or first maximum flow rate, in accordance with some embodiments of the present disclosure;

FIG. 3 illustrates a cross-sectional view of a second venting structure, which is an umbrella valve configured to vent at a second flow rate or second maximum flow rate, in accordance with some embodiments of the present disclosure;

FIG. 4 illustrates a cross-sectional view of a deformable venting structure, which is a burst disk configured to vent at a third flow rate or third maximum flow rate, in accordance with some embodiments of the present disclosure;

FIG. 5 illustrates a bottom view of an umbrella valve having a plurality of supports defining channels for venting, in accordance with some embodiments of the present disclosure;

FIG. 6 illustrates a bottom view of an umbrella valve comprised of a deformable venting structure, in accordance with some embodiments of the present disclosure;

FIG. 7 shows a flowchart of an illustrative process 700 for assembling a battery pack having a plurality of vent structures to accommodate a first or first maximum flow rate, a second or second maximum flow rate, and a third or third maximum flow rate, in accordance with some embodiments of the present disclosure. In an illustrative example, process 700 may be used to form battery pack 100 of FIG. 1, including vent plug valve 200 of FIG. 2, umbrella valve 300 of FIG. 3, deformable venting structure 400 of FIG. 4, deformable umbrella support 500 of FIG. 5, deformable umbrella 600 of FIG. 6, or any combination thereof;

FIG. 8 shows a schematic diagram of an illustrative vehicle and a battery pack assembly, in accordance with some embodiments of the present disclosure;

FIG. 9 shows a flowchart of an illustrative process for receiving and processing data from sensors arranged to provide a vehicle information about a battery pack assembly, in accordance with some embodiments of the present disclosure.

### DETAILED DESCRIPTION

Modern vehicles and other infrastructures supporting a plurality of electronically powered devices, particularly for vehicle propulsion, may utilize a plurality of battery cells packaged together to create battery packs or assemblies. The cells may be included in a plurality of modules or assemblies within the pack. In some battery packs, the battery cells generate heat which can lead to damage to the battery cells if the heat is not vented from the battery packs. Some battery packs rely on passive venting of heat through a membrane, e.g., formed of a synthetic fluoropolymer, fixed in a port. However, these fixed venting devices are generally not capable of venting heat rapidly or in a larger volume, e.g., in response to an event causing a rapid buildup of heat and pressure in the battery pack.

Movable valves, e.g., umbrella valves, comprised of a movable membrane, may permit gas to escape a battery pack while generally preventing ingress of water or other liquids. Assemblies utilizing umbrella valves of this nature may be deficient in that water and humidity can still enter the battery pack as the umbrella valves lack sealing around the interface securing the valve to the battery pack. Additionally, these valves tend to protrude outwards from the face of the battery pack on which they are installed. This protrusion may cause damage to the valves during installation and packaging, which may lead to the ingress of water during the use of the battery pack. Moreover, these movable valves may not provide sufficient venting under extreme temperature or pressure events.

These and other deficiencies are addressed by the example battery packs and methods described herein. In some embodiments, a plurality of venting devices or structures may be provided to increase ventilation sufficient to vent relatively larger quantities of heat from a battery pack or assembly, while also improving sealing of the battery pack against water intrusion. The plurality of venting structures may include different types or venting capabilities, thereby allowing a generally staged venting of the battery pack in response to different events. For example, the venting structures may include a plurality of valves, including a fixed or plug-type that generally permits a relatively low rate of venting, e.g., to respond to a slow or small increase of pressure inside the battery pack. Another of the plurality of valves may be a movable or umbrella-type valve, which has a movable membrane or other sealing structure that temporarily deflects to release pressure from the enclosure. The movable valve may vent from the enclosure at a second rate that exceeds that provided by the plug/fixed valve. The venting structures, in addition to the plurality of valves, may also include a deformable venting structure that is configured to physically deform or otherwise mechanically fail, e.g., by melting, bursting, or the like, to enable a rapid release of heat and/or pressure from the enclosure. Accordingly, heat and pressure building up at a rate that cannot be mitigated by the fixed and/or movable valves may be vented from the enclosure through the deformable venting structure. In some examples, mechanical failure of the deformable venting structure creates or enlarges an opening in the enclosure walls to provide venting. The opening may be positioned to minimize a risk of water ingress based on expected water levels that the vehicle may traverse. The opening may also provide an external visual indication or cue with respect to a thermal or pressure event within the enclosure of the battery pack, facilitating replacement or service of the battery pack. For example, venting structure(s) may be formed out of a material that changes color upon exposure to a temperature or pressure above a threshold limit. In one example, a light-colored resin (e.g., a white resin) becomes a darker color (e.g., brown or black) when the deformable venting structure is exposed to a temperature or pressure exceeding a predetermined threshold or limit.

In some example approaches, there are a plurality of each of the different venting structures, e.g., multiple vent plugs, umbrella valves, and deformable venting structures, based on expected heat or pressure loads of the enclosed battery cells, and/or the power output capacity of the battery cells. In some embodiments, deformable venting structures may be incorporated into the valves, e.g., by way of a deformable structure that is part of a movable or umbrella valve. This combination of multiple venting structures in a single venting device, e.g., a movable or umbrella valve, may advantageously reduce the number of openings in the battery pack enclosure and/or sealing interfaces.

Accordingly, example battery systems and methods herein may generally vent heat and/or pressure at three different flow rates to address three different types of thermal or pressure issues affecting battery cell performance. Thus, example battery packs may respond to different heat and pressure events, as well as multiple occurrences of different heat and pressure based events, without requiring servicing of or replacement of the battery pack or enclosure. Additionally, this approach generally seals water and other contaminants from entering the battery enclosure. The approach of the present disclosure also addresses the deficiencies in previous designs, in which valves and other vents may protrude from the face of a battery enclosure, e.g., beyond an outer wall surface, whereas the venting structures of the present disclosure may be embedded in the walls of the enclosure such that an outermost portion of the venting structure and/or valve does not protrude beyond a planes of the outer surface of the enclosure.

In some embodiments, each of the plurality of venting structures are positioned within the enclosure walls by a threaded portion, and the entire venting structure is positioned such that it remains within an inner surface of the enclosure walls and/or does not protrude beyond an outer surface of the enclosure walls. In some such examples, a radial seal is positioned between a threaded shank or portion of each of the plurality of valves and a radially outer face of the valve to prevent the ingress of water from the environment surrounding the battery enclosure.

In some examples, a battery enclosure is in communication with vehicle control circuitry configured to process signals from a plurality of sensors installed within the battery pack or enclosure. The plurality of sensors may include at least one of temperature sensor, a voltage sensor, a pressure sensor, or a sensor configured to detect standing water within the battery enclosure. Each of these sensors may be configured to collect data related to the conditions inside and surrounding the battery enclosure. The data is processed by vehicle systems comprised of control circuitry configured to provide statuses and warnings to users of the vehicle systems.

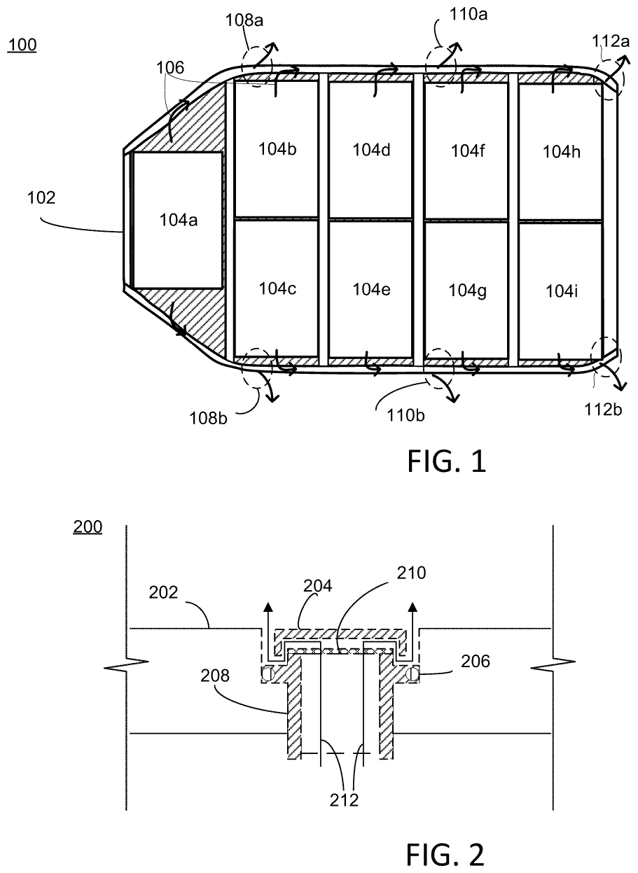

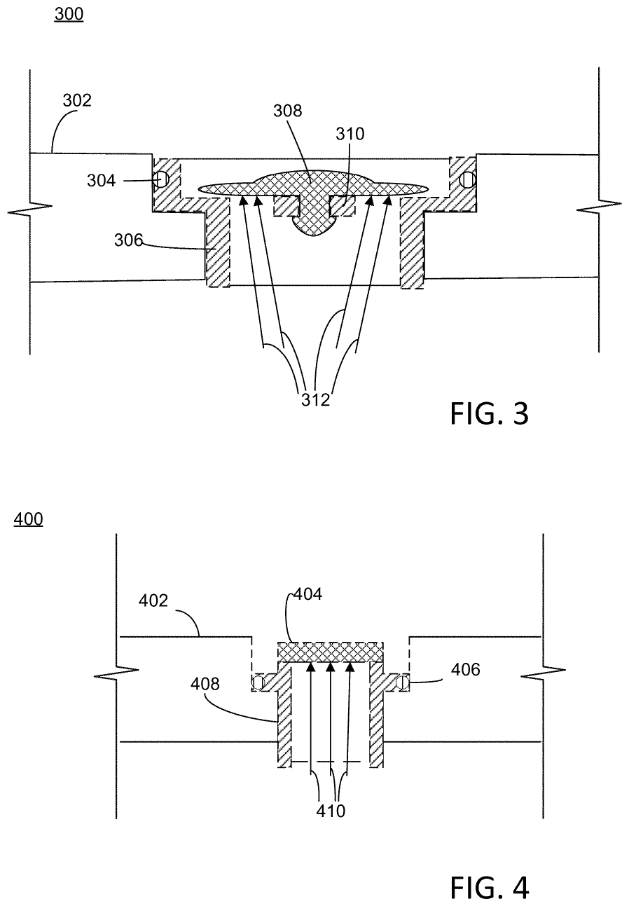

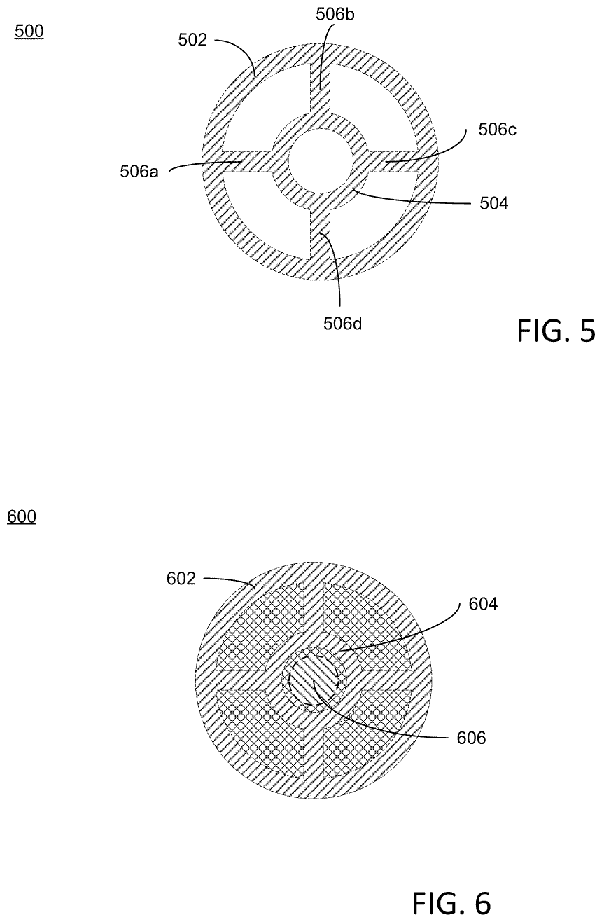

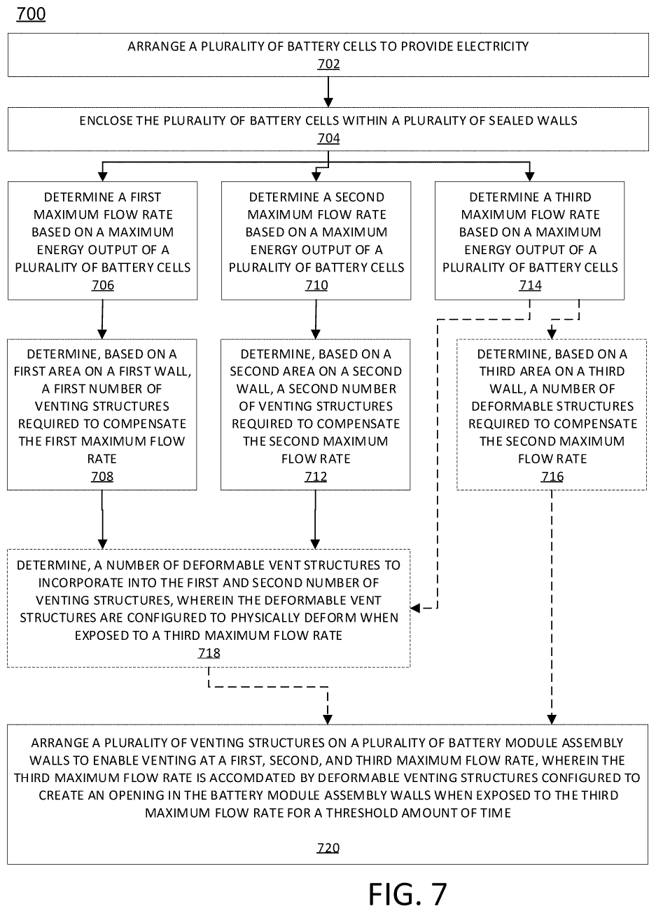

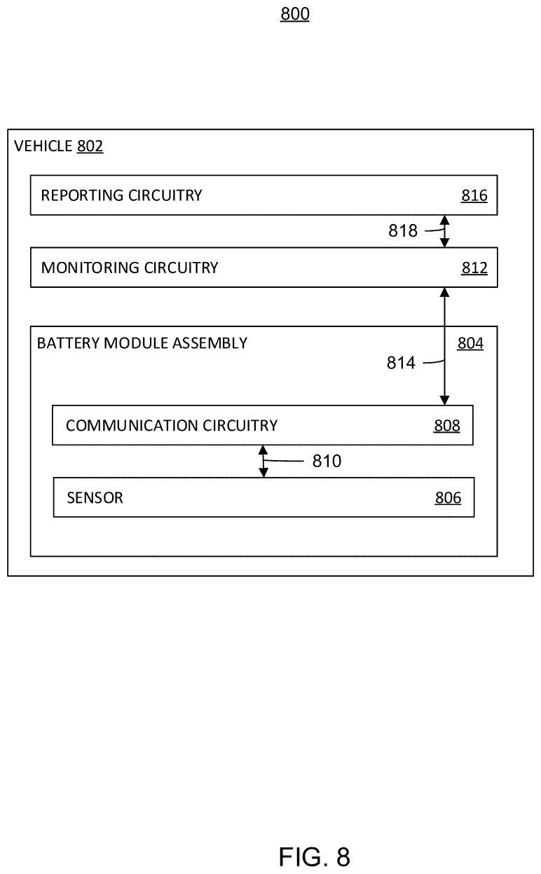

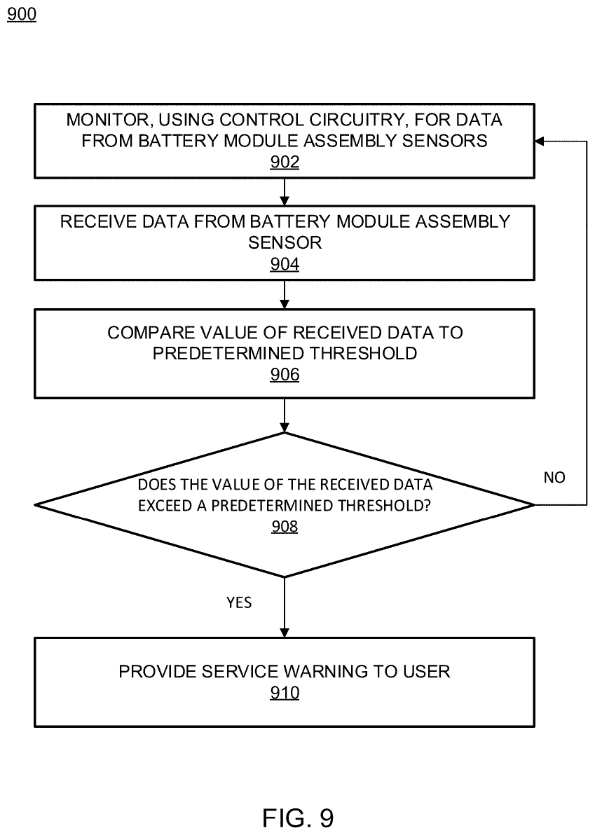

Referring now to FIG. 1 an example battery pack or assembly 100, which may generally represent an example embodiment of the systems and methods described herein. The battery pack 100 is illustrated as having a plurality of venting structures 108, 110, and 112. As will be discussed further below, the venting structures may include valves such as a vent plug valve 200 (see FIG. 2), a movable or umbrella valve 300 (see FIG. 3). One or more of the venting structures 108, 110, 112 may also include a deformable venting structure. In some examples the deformable venting structure may be a separate component or device from other venting structures of the pack 100, e.g., in the form of a deformable burst disk venting structure 400 (see FIG. 4). However, in other examples a deformable venting structure may be incorporated with a movable valve, e.g., as will be described further below in regard to a radial support valve 500 (see FIG. 5) or burst disk umbrella 600 (see FIG. 6). Accordingly, radial support valve 500 and/or burst disk umbrella 600 may be incorporated into battery pack 100 in combination or in place of vent plug 200 and/or umbrella valve 300. As will also be described further below, battery pack 100 may also be configured consistent with method 700 of FIG. 7, and may be incorporated into vehicle system 800 of FIG. 8 as battery pack assembly 804. Battery pack 100 may also be configured with sensors to the extent necessary to facilitate execution of method 900 of FIG. 9.

Referring now to FIG. 1, battery pack 100 may be enclosed by wall assembly 102. Wall assembly 102 may create an enclosure around battery cell modules or assemblies 104a-i. Each of the modules 104 may include one or more, and in some cases many, battery cells. The enclosure of the pack 100 may be substantially sealed. More specifically, fluid flow into and out of the enclosure defined by the wall assembly 102, e.g., of ambient air, may be limited to that permitted by the venting structures 108, 110, and 112, as will be discussed further below. Accordingly, an increase of pressure and/or temperature within the wall assembly 102, e.g., due to an increase of the temperature of the battery module assemblies 104, venting from the modules 104a-i, etc. may generally cause an increase in pressure within the wall assembly 102. Accordingly, excess pressure may be vented from within the enclosure of the wall assembly 102 by way of one or more of the venting structures 108, 110, 112. Battery module assemblies 104a-i may be comprised of a plurality of battery cells that are interconnected to generate an amount of electrical energy to be provided to a larger vehicle system. Battery module assemblies 104a-i may be arranged vertically, horizontally, or may be stacked over each other depending on the available packing space of the structure battery pack 100 is configured to provide electrical power for. Battery module assemblies 104a-i may be separated by dividing walls which may create channels for heat generated by battery module assemblies 104a-i. Flow(s) 106 depicts possible paths of pressure and/or heat generated by battery module assemblies 104a-i. The flow(s) 106 may manifest in a plurality of levels based on the usage of battery module assemblies 104a-i or other conditions of the battery pack 100. For example, battery module assemblies 104a-i may generate lower amounts of pressure or heat at lower rates when the current draw created by the system that battery module assemblies 104a-i are arranged within is at a low or normal operating level. By contrast, as will be discussed further below, greater amounts of pressure and/or heat may be vented through the other vent structures 108, 110, and/or 112 in response to more significant or rapid buildup of pressure within the wall assembly 102.

In another example, a current draw amount and resulting heat output or pressure within the battery module 100 may be related to a number of vehicle systems in active use, e.g., as part of an electric vehicle utilizing battery module assembly 100 for power supply and/or storage. For example, a first amount of pressure or heat may be generated when the vehicle is only using auxiliary power to monitor for a vehicle activation command (e.g., 12 Watts which equates to a heat output of 12 Joules per second), a second amount of pressure may be generated when the vehicle is using an idle amount of power when the vehicle is powered on to enable a majority of the vehicle systems to function and operate at a steady state (e.g., 18 Watts which equates to a heat output of 18 Joules per second), and a third amount of pressure may be generated when the vehicle is using a higher or maximum amount of power when the vehicle and the systems within the vehicle are all operating at a higher or maximum capacity (e.g. 36 Watts which equates to a heat output of 36 Joules per second). Each of these outputs may propagate throughout battery pack 100 by exemplary flow 106 based on the arrangement of a plurality of walls that comprise wall assembly 102 as well as the energy outputs and positioning of battery module assemblies 104a-i.

In another example, the battery module assembly 100 is configured to vent from within the module 100 in response to different levels or thresholds of internal pressure or heat. More specifically, one or more vent plug valves may be configured to vent a first amount of pressure, e.g., 5 kPa of pressure within the battery module 100, which may be created by heat generated by battery cells operating within battery module assembly 100. Higher levels of pressure may be vented from the module 100 via other vent structures. More specifically, a moveable or umbrella-type valve may be configured to vent higher levels of pressure, e.g., 10 kPa of pressure within the battery module 100, in response to higher levels of heat output by the battery cells or other conditions creating additional pressure within the module 100. Further, higher levels of pressure and/or heat, e.g., 50 kPa of pressure or 600° C., may be vented from the module 100 by a deformable valve. Each of these outputs may propagate throughout battery module assembly 100 by exemplary flow 106 based on the arrangement of a plurality of walls that comprise wall assembly 102.

In another example, the conditions within battery pack 100 may result in an elevated pressure either as a direct result of the heat generated from battery module assemblies 104a-i or by some other conditions caused by the operation of battery pack 100. For example, the conditions within battery pack 100 may typically be at an ambient pressure such as 1 atm. Between the operation of the vehicle and the current draw from battery module assemblies 104a-i, the conditions within battery pack 100 may change from 1 atm to 1.1 atm which may create flow(s) 106 of gas particles that need to be vented at 0.001 m³/second passively while the vehicle is only using auxiliary power to monitor for a vehicle activation command corresponding to a first flow rate or first maximum flow rate to be relieved. A second maximum flow rate may correspond to a change in pressure from 1 atm to 1.4 atm which may create flow(s) 106 of gas particles that need to be vented at 0.01 m³/second more actively while the vehicle is powered on to enable a majority of the vehicle systems to function and operate at a steady state. A third flow rate or third maximum flow rate may correspond to a change in pressure from 1 atm to 2.5 atm which may create flow(s) 106 of gas particles that need to be vented at 1 m³/second almost immediately when the vehicle is using a high or maximum amount of power when the vehicle and the systems within the vehicle are all operating at a maximum capacity for a period beyond a design threshold.

In some embodiments, battery pack 100 incorporates multiple types of venting structures throughout wall assembly 102. Each of the venting structures may be arranged such that they vent out the sides of wall assembly 102. The venting structures may be arranged based on a consideration of flow(s) 106 to minimize a buildup of pressure or heat in a particular section of battery pack 100. For example, a first venting structure type may be vent ports 108a and 108b. In this example, based on flow 106 there are only battery module assemblies 104a-c subjected to flow 106. Accordingly, pressure and/or heat may build up at a slower rate. Vent ports 108a and 108b may each include vent plug 200 of FIG. 2 and may positioned at a fixed height relative to an embedded thread in wall assembly 102. The fixed height may be determined based on a cross sectional flow area to enable lower levels of pressure and/or heat to be expelled form vent ports 108a and 108b while creating an egress flow that prevents the ingress of humidity or other fluids into vent ports 108a and 108b. In an example, the vent plug 200 may be configured to vent from the module 100 sufficiently to address an excess pressure within the pack 100 of 5 kPa.

A second venting structure may be umbrella valves 110a and 110b. In this example, based on flow 106 there are now battery modules 104a-g subjected to flow 106. Accordingly, pressure and/or heat may build up at a faster rate, e.g., to create an internal pressure within battery pack 100 exceeding 10 kPa. Also in this example, vent ports 108a and 108b may be in position to relieve a portion of the heat build up at a passive rate such that not all of the pressure or heat generated by battery module assemblies 104a-g must be relieved by umbrella valves 110a and 110b. Umbrella valves 110a and 110b may be depicted by umbrella valve 300 of FIG. 3 and may incorporate deformable features of radial support valve 500 of FIG. 5 and burst disk umbrella 600 of FIG. 6 depending on the expected heat output of the arrangement of battery module assemblies 104a-i within battery pack 100. Umbrella valves 110a and 110b may be configured to maintain a seal on wall assembly 102 until flow 106 produced by battery modules 104a-g creates sufficient pressure and/or temperature to create a response by the valves 110a and/or 110b. In this example, when flow 106 reaches an elevated level, umbrella valves 110a and 110b may be configured to create an opening to the environment external to battery pack 100 to release the pressure and/or heat from within wall assembly 102.

A third venting structure may be a deformable venting structure 112, which as illustrated in FIG. 1 may take the form of burst disks 112a and 112b. In this example, based on flow 106 there is now a further increase in pressure within the pack 100 and/or flows 106, e.g., due to an increased number of battery module assemblies 104a-i venting, or a more extreme events causing excess pressure and/or heat within the pack 100. Accordingly, pressure may build up at a significantly faster rate to create a pressure within battery pack 100 exceeding 50 kPa, and/or a temperature exceeding 600° C. As a result, venting by vent plug or moveable/umbrella-type vent valves alone may not be sufficient to facilitate venting from the pack 100. Also in this example, burst disks may be positioned at a collection position of this pressure/heat based on the direction of flow 106, which may depend on the configuration of wall assembly 102 and the relative positioning of battery module assemblies 104a-i within battery pack 100. Burst disks 112a and 112b may be depicted by burst disk 400 of FIG. 4. Burst disks 112a and 112b may be configured to maintain a seal for wall assembly 102 and may be comprised of a deformable structure configured to mechanically fail and break open at a rapid rate corresponding to a pressure or heat build-up, e.g., exceeding 50 kPa or 600° C., so as to prevent battery module assemblies 104a-i from being exposed to a heat flow of that level for an extended period of time. Vent ports 108a and 108b as well as umbrella valves 110a and 110b may also incorporate deformable structures in accordance with some embodiments of this disclosure should battery module assemblies 104a-i repeatedly produce flow 106 that exceeds a high or maximum allowable pressure or heat.

In some embodiments, once flow 106 exceeds the exemplary maximum pressure/heat level, a warning may be generated for service to battery pack 100. For example, once the exemplary or maximum heat flow is achieved there may be openings in battery wall assemblies 102 which may enable ingress of fluids into battery pack 100 depending on the operating conditions, e.g., as a result of physical or permanent mechanical failure of one or more of the deformable venting structures 112. In some embodiments, there may be control circuitry arranged within battery pack 100 which comprises a plurality of sensors (e.g., a water sensor configured to detect standing water within the battery pack assembly, a temperature sensor, a voltage sensor, and a pressure sensor). These sensors may be configured to provide data and warnings to a vehicle operator as exemplified in process 900 of FIG. 9.

FIG. 2 illustrates a cross-sectional view of exemplary vent plug 200 venting heat at a first maximum flow rate, in accordance with some embodiments of the present disclosure. The vent plug 200 may also generally permit a gaseous flow into the enclosure to enable a steady state operating pressure (e.g., due to thermal contraction as one or more battery modules 104a-i cool), while also venting lower levels of heat and/or pressure out of the enclosure. Vent plug 200 may be incorporated into battery pack 100 as vent ports 108a and 108b, in an example. Vent plug 200 may also incorporate aspects of radial support valve 500 of FIG. 5 and burst disk umbrella 600 of FIG. 6.

Vent plug 200 may be embedded in wall 202. Wall 202 may represent wall assembly 102 of FIG. 1, merely as one example. Vent plug 200 may be positioned when installed such that the vent plug 200 does not protrude through a plane defined by the outer surface of wall 202. A top-most portion of vent plug 200 may be vent cap 204. Vent cap 204 may comprise openings to enable heat flow 212 to reach the environment surrounding battery pack 100 from FIG. 1, or may create channels as depicted in FIG. 2 to enable flow 212 to act as an egress pressure or heat flow to inhibit the ingress of fluids from the environment from entering vent plug 200. Vent cap 204 is positioned to enable a first maximum flow rate of heat to exit battery pack 100 (e.g., a flow rate as created by 5 kPa of internal pressure which enables the venting of excess pressure or heat through vent cap 204). In some embodiments, vent cap 204 may include deformable portions such as radial support valve 500 of FIG. 5 and burst disk umbrella 600 of FIG. 6 to address heat flow of a third maximum flow rate.

Radial sealing ring 206 may be situated in a groove to create a seal against the sidewalls created by the opening to situate vent plug 200. Radial seal ring 206 may be comprised of any material that is known to seal against the ingress of fluids that battery pack 100 of FIG. 1 may be situated in, e.g., a compliant material such as silicone, rubber, or the like. Radial seal ring 206 may be decoupled from the loads experienced by threaded portion 208. In some embodiments, this may enable the use of a relatively small thicknesses of wall 202, as the seal is not dependent upon thread loads provided by the threaded portion 208. Threaded portion 208 may be situated below radial seal ring 206 and may mate with a threaded portion of wall 202 to enable positioning of vent plug within wall 202 to prevent vent cap 204 from protruding beyond a plane defined by the surrounding outer surface. In some embodiments, threaded portion 208 is configured to reduce thread loads provided by thread engagement based on the thickness of wall 202. Permeable membrane 210 may be comprised of a material that enables the egress of heated gas from inside battery pack 100 to the environment surrounding battery pack 100 while also preventing the ingress of fluids known to be in the environment surrounding battery pack 100. The egress of pressure and/or heat is depicted by flow 212. Permeable membrane 210 may be configured to withstand lower levels of temperature and/or pressure, e.g., a first and a second maximum heat or pressure flow rates and may be configured to fail at a third maximum flow rate. In an example, lower levels of pressure such as 5 kPa or 10 kPa may be sufficiently addressed by vent cap 204 and/or permeable membrane 210, while higher levels of temperature and/or pressure (e.g., 50 kPa or 600° C.) may require additional venting capability, as will be discussed further below.

FIG. 3 illustrates a cross-sectional view of umbrella valve 300 venting heat at a second maximum flow rate, in accordance with some embodiments of the present disclosure. Umbrella valve 300 may be incorporated into battery pack 100 as umbrella valves 110a and 110b. Umbrella valve 300 may, in some examples, also incorporate aspects of radial support valve 500 of FIG. 5 and burst disk umbrella 600 of FIG. 6.

Umbrella valve 300 may be embedded in wall 302. Wall 302 may represent a wall of wall assembly 102 of FIG. 1. Umbrella valve 300 may be configured such that in its embedded position the entire assembly that comprises umbrella valve 300 does not protrude through a plane defined by the outer surface of wall 302. Radial sealing ring 304 may be situated in a groove to create a seal against the sidewalls created by the opening to situate umbrella valve 300. Radial seal ring 304 may be comprised of any material that is known to seal against the ingress of fluids that battery pack 100 of FIG. 1 may be situated in. Threaded portion 306 may be situated below radial seal ring 304 and may match the threaded portion of wall 302 to enable positioning of vent plug within wall 302 to prevent a top-most portion of umbrella valve 300 from protruding beyond a plane defined by the surrounding outer surface.

Umbrella seal 308 may be comprised of a material that enables the egress of heated gas from inside battery pack 100 to the environment surrounding battery pack 100 while also preventing the ingress of fluids known to be in the environment surrounding battery pack 100. The egress of pressure and/or heat is depicted by flow 312. Umbrella seal 308 may be configured to create a gap between umbrella seal 308 and the body of umbrella valve 308 to enable to egress of heat when the heat level matches or exceeds a second maximum flow rate and may be configured to fail at a third maximum flow rate. Umbrella seal 308 may be held in position by support structure 310. Support structure 310 may comprise openings to enable flow 312 to reach the environment surrounding battery pack 100 from FIG. 1, when enough heat is generated to displace the edges of umbrella seal 308 (e.g. there is at least 10 kPa of pressure inside the battery pack). In some embodiments, support structure 310 may include deformable portions such as radial support valve 500 of FIG. 5 which may be configured to deform when exposed to a third maximum flow rate (e.g., a gas flow rate an enabled by an internal battery pack pressure exceeding 50 kPa or a temperature exceeding 600° C.). In some embodiments, the umbrella seal may be comprised of burst disk umbrella 600 to address flow at third maximum flow rate.

FIG. 4 illustrates a cross-sectional view of burst disk assembly 400, which may be configured to vent from the enclosure of the pack 100 at a third maximum flow rate in accordance with some embodiments of the present disclosure. Burst disk assembly 400 may be incorporated into battery pack 100 as deformable venting structures 112a and 112b. Burst disk assembly 400 may also incorporate aspects of radial support valve 500 of FIG. 5 and burst disk umbrella 600 of FIG. 6.

Burst disk assembly 400 may be embedded in wall 402. Wall 402 may represent a wall of wall assembly 102 of FIG. 1. Burst disk assembly 400 may be configured such that in its final adjusted position the entire assembly that comprises burst disk assembly 400 does not protrude through a plane defined by the outer surface of wall 402. A top-most portion of burst disk assembly 400 may be deformable portion 404. Deformable portion 404 may be configured to create a seal to inhibit the ingress of fluids from the environment from entering vent plug 200. Deformable portion 404 may be configured to deform and create an opening when exposed to a heat flow that exceeds a third maximum flow rate to enable heat flow 410 to exit battery pack 100 (e.g., may melt when exposed to more than 50 kPa of internal pressure or 600° C.). For example, deformable portion 404 when it deforms may leave a visual indication of a thermal event either by a color change or other residue remaining as a result of the event in addition to an open space where deformable portion 404 was located prior to deforming as a result of being exposed to the event. In some embodiments, deformable portion 404 may include deformable structures such as radial support valve 500 of FIG. 5 and burst disk umbrella 600 of FIG. 6 to address flow of a third maximum flow rate. In some embodiments, these other structures may be incorporated into the shape of deformable portion 404 to enable burst disk assembly 400 to contribute to venting of a relatively lower flow rate, e.g., the first and/or second maximum flow rates discussed above, to reduce a probability that battery pack 100 reaches a pressure/temperature within the wall assembly 102 to create increased flow from the enclosure, e.g., at a further increased flow rate such as the third maximum flow rate.

Radial sealing ring 406 may be situated in a groove to create a seal against the sidewalls created by the opening to situate burst disk assembly 400. Radial seal ring 406 may be comprised of any material that is known to seal against the ingress of fluids to battery pack 100 of FIG. 1, e.g., water. Threaded portion 408 may be situated below radial seal ring 406 and may match the threaded portion of wall 402 to enable positioning of burst disk assembly 400 within wall 402 to prevent deformable portion 404 from protruding beyond a plane defined by the surrounding outer surface. Deformable portion 404 may be comprised of any material suitable to create a seal to prevent fluids or gas from entering battery pack 100 based on the anticipated environment of battery pack 100 while also being made of a material structured to deform and create an opening when exposed to a heat level exceeding a third maximum heat level (e.g., when exposed to conditions related to an internal pressure of the battery pack or a module exceeding 50 kPa, or a temperature within the pack 100 exceeding 600° C.). The egress of pressure/heat is depicted by flow 410. Deformable portion 404 may be configured to withstand a first and a second maximum heat flow rates (e.g., gas flow rates corresponding to internal battery pack pressures of 5 kPa and 10 kPa, respectively) and may be configured to fail at higher levels of temperature and/or pressure, e.g., a third maximum flow rate. In some embodiments, deformable portion 404 may incorporate structural elements to enable the egress of the first and the second maximum heat flow rate without deforming.

FIG. 5 illustrates a bottom view of deformable structure 500 which may be incorporated in umbrella valve 300 as support structure 310, both of FIG. 3, in accordance with some embodiments of this disclosure. Deformable structure 500 may also be incorporated into vent plug 200 as a support structure for permeable membrane 210, both of FIG. 2, and may be incorporated into burst disk assembly 400 as part of deformable structure 404, both of FIG. 4.

Deformable structure 500 may have an outer perimeter defined by support ring 502. Outer support ring 502 may be the diameter of a portion of a wall of wall assembly 102 of FIG. 1 that is bored out and tapped to allow the insertion of one of vent plug 200 of FIG. 2, umbrella valve 300 of FIG. 3, or burst disk assembly 400 of FIG. 4. Inner support ring 504 may be the diameter of a lower portion of umbrella seal 308 of FIG. 3. Connecting inner support ring 504 to outer support ring 502 are support arms 506a-d. In some embodiments, there may be more or less than the pictured four support arms 506a-d depending on the thickness of wall assembly 102 of FIG. 1 and the third maximum flow rate anticipated to be produced within battery pack 100 of FIG. 1.

Support arms 506a-d may be made of a type of material that is structured to deform or melt when exposed to a third maximum flow rate for a threshold amount of time, e.g., plastic, nylon, or the like. For example, the third maximum flow rate may be caused by an internal battery pack temperature of 600° C. or 50 kPa of pressure within the battery pack and the threshold amount of time may be one second. In this example, support arms 506a-d are structured to melt when exposed to the above-mentioned conditions for at least one second. In some embodiments, deformable structure 500 may be configured as support structure 310 of FIG. 3. In this embodiment, when support arms 506a-d melt umbrella seal 308 may fall outside of battery pack 100 of FIG. 1 and create an opening in wall assembly 102 of FIG. 2 to enable heat to egress from the enclosure created by wall assembly 102 at a rapid rate. In an example, each of support arms 506a-d may have a relatively narrow radial width while having a relatively larger axial height so as to maintain a structurally sound cross sectional area while also enable rapid melting and egress of heated/pressurized gas during an event corresponding to the third maximum flow rate.

FIG. 6 illustrates a bottom view of burst disk umbrella 600 which may be incorporated in umbrella valve 300 as umbrella seal 308, both of FIG. 3, in accordance with some embodiments of this disclosure. Burst disk umbrella 600 may also be incorporated into vent plug 200 as an alternative embodiment of permeable membrane 210, both of FIG. 2, and may be incorporated into burst disk assembly 400 as part of deformable structure 404, both of FIG. 4.

Burst disk umbrella 600 may have an outer perimeter defined by support ring 602. Outer support ring 602 may be the diameter of a portion of a wall of wall assembly 102 of FIG. 1 that is bored out and tapped to allow the insertion of one of vent plug 200 of FIG. 2, umbrella valve 300 of FIG. 3, or burst disk assembly 400 of FIG. 4. Inner support ring 604 may be the diameter of a lower portion of umbrella seal 308 of FIG. 3. Connecting inner support ring 504 to outer support ring 502 are support arms. In some embodiments, there may be more or less than the pictured four support arms depending on the thickness of wall assembly 102 of FIG. 1 and the third maximum flow rate anticipated to be produced within battery pack 100 of FIG. 1.

The support arms may be configured to maintain their shape and structure despite being exposed to a third maximum flow rate. In some embodiments, umbrella burst disk diameter 606 may be configured to melt, fail, deform, or otherwise physically deform when exposed to a third maximum flow rate for a threshold amount of time to enable a rapid egress of heat from inside battery pack 100 of FIG. 1 to the environment surrounding battery pack 100. For example, in response to an internal pressure within the module 100 of 50 kPa or 600 degrees Celsius for at least one second, the umbrella burst disk diameter 606 may be configured to melt or otherwise physically deform. In some embodiments, burst disk umbrella 600 may be configured as umbrella seal 308 of FIG. 3. In this embodiment, when umbrella burst disk diameter 606 melts umbrella seal 308 may retain a seal at the surrounding outer perimeter while the open diameter where umbrella burst disk diameter 606 was creates an opening so that heat may flow outside of battery pack 100 of FIG. 1 and create a small in wall assembly 102 of FIG. 2 to enable heat to egress from the enclosure created by wall assembly 102 at a rapid rate. In some embodiments, umbrella burst disk diameter 606 may be smaller in diameter than deformable portion 404 of FIG. 4 such that when a heat flow event exceeding a third maximum flow rate for a threshold period of time occurs there is a smaller opening in a wall of wall assembly 102 of FIG. 1.

FIG. 7 shows a flowchart of illustrative process 700 for making a battery pack configured with a plurality of vents to accommodate a first maximum flow rate, a second maximum flow rate, and a third maximum flow rate, in accordance with some embodiments of the present disclosure. In an illustrative example, process 700 may be used to form battery pack 100 of FIG. 1, vent plug 200 of FIG. 2, umbrella valve 300 of FIG. 3, burst disk 400 of FIG. 4, deformable structure 500 of FIG. 5, burst disk umbrella 600 of FIG. 6, or any combination thereof in accordance with some embodiments of this disclosure.

At 702, a plurality of battery cells are arranged to provide electricity. In some embodiments the plurality of battery cells may be arranged within battery pack 100 of FIG. 1 to power a vehicle. In some embodiments, the plurality of battery cells are arranged to provide power by being connected through a network of connections between battery cell terminals. At 704, the plurality of battery cells may be enclosed within a plurality of walls that are sealed against the environment in which the plurality of battery cells is positioned (e.g. enclosed within wall assembly 102 of FIG. 1). At 706, a first maximum pressure level or flow rate or heat or pressure may be determined, e.g., based on the maximum energy output of a plurality of battery cells during normal operating conditions. For example, the first maximum flow rate may reflect a vehicle, in which battery pack 100 of FIG. 1 may be installed, that is only using lower levels of power, e.g., auxiliary power to monitor for a vehicle activation command. At 708, based on a first area of on a first wall, a number of first venting structures or vent types is determined to compensate the first maximum flow rate. In some embodiments, the venting structures may be one or more fixed vents, such as vent plugs 200 of FIG. 2.

At 710, a second temperature, or heat or pressure flow rate may be determined based on a second amount of heat generated by a plurality of battery cells. For example, the second maximum flow rate may reflect when a vehicle, in which battery pack 100 of FIG. 1 may be installed, is using a maximum amount of power when the vehicle is powered on (e.g., a flow rate of gas leaving the battery pack through a venting structure corresponding to 10 kPa of pressure created by heat generated by battery cells operating within battery pack 100). At 712, based on a second area on a second wall, a second number of second venting structures or vent types is determined to compensate the second maximum flow rate. In some embodiments, the venting structures may be a plurality of movable valves, such as umbrella valve 300 of FIG. 3.

At 714, a third maximum flow rate may be determined based on a third amount of heat generated by a plurality of battery cells. For example, the third amount of heat may reflect a vehicle, in which battery pack 100 of FIG. 1 may be installed, that is undergoing an extreme event such as a thermal event or other extreme condition of one or more of the battery modules 104a-i (e.g., a flow rate of gas leaving the battery pack as caused by an internal temperature of at least 600° C. and/or 50 kPa of pressure within the battery pack). At 716, based on a third area on a third wall, a third number of third venting structures or vent types is determined to compensate the third maximum flow rate and the third venting structures may comprise a set of deformable structures. In some embodiments, at 718 a number of deformable structures is determined as needing to be incorporated into the first and second number of venting structures determined at 708 and 712, respectively. In some embodiments, steps 716 and 718 are performed together should it be determined that modifying the first and second venting structures will not compensate the third maximum flow rate appropriately. In some embodiments, only 716 is performed to reduce the number of openings created in the event of a third maximum flow rate. In some embodiments, only 718 is performed to reduce the number of sealing interfaces added to the plurality of walls.

At 720, a plurality of venting structures are arranged within the plurality of walls to compensate the first, second, and third maximum flow rates and may incorporate a plurality of deformable structures specifically to compensate the third maximum pressure or flow rate for a threshold amount of time. For example, the threshold amount of time may be one second and the third maximum pressure may be 50 kPa. In this example, the deformable structures arranged in the walls may be structure to melt or fail after being exposed to a temperature of 600° C. and/or 50 kPa of internal pressure for at least one second, thereby creating an enlarged opening to allow rapid venting of the heat built up within battery pack 100 of FIG. 1.

FIG. 8 shows a block diagram of an illustrative vehicle system 800 including vehicle 802 and battery pack 804, in accordance with some embodiments of the present disclosure. Battery pack 804 may incorporate any or all of the elements depicted in battery pack 100 of FIG. 1, which may incorporate any or all of the features of FIGS. 1-6 as created by method 700 of FIG. 7, in accordance with some embodiments of this disclosure.

In some embodiments, vehicle 802 may be comprised of battery pack 804, monitoring circuitry 812, and reporting circuitry 816. Battery pack 804 may further comprise sensor 806 and communication circuitry 808. In some embodiments, there may be a plurality of sensors. In some embodiments, the plurality of sensors may comprise at least one of a water sensor configured to detect standing water within the battery pack, a temperature sensor, a voltage sensor, or a pressure sensor. In embodiments where one or a plurality of sensors are used, battery pack 804 may utilize control circuitry to connect the one or the plurality of sensors to vehicle 802.

In some embodiments, communication circuitry 808 may be configured to receive data from sensor 806 by communication path 810. In some embodiments, communication circuitry 808 may communicate the data from sensor 806 to monitoring circuitry 812 by communication path 814. In some embodiments, monitoring circuitry 812 may be configured to be external to battery pack 812. In some embodiments, monitoring circuitry 812 may utilize a comparison method to determine whether to provide data from sensor 806 to reporting circuitry 816 by communication path 818. In some embodiments, the comparison method of monitoring circuitry 812 may compare a data value received from sensor 806 as reported by communication circuitry 808 to a threshold hold. For example, sensor 806 may be a water level sensor. In this example, sensor 806 detects a level of water sitting within battery pack 804, e.g., one (1) centimeter (cm). The water level data value (continuing with this example, 1 cm) may be transmitted from communication circuitry 808 to monitoring circuitry 812 by communication path 814. Monitoring circuitry may compare the 1 cm data value from sensor 806 to a threshold value, e.g., 0.5 centimeters. In this example, monitoring circuitry 812 may determine the amount of water reported by sensor 806 within battery pack 804 exceeds the threshold and may send a notice to reporting circuitry 816 by communication path 818 that a service notice must be generated. In some embodiments, reporting circuitry 816 may cause a notification to be generated for vehicle 802 that service is required within battery pack 804 (e.g., a warning may be generated that water has entered batter pack 804 and service is required.)

FIG. 9 shows a flowchart of notification process 900 for receiving and processing data from sensors arranged to provide a vehicle information about a battery pack, in accordance with some embodiments of the present disclosure. Notification process 900 may be executed by vehicle system 800 of FIG. 8 and may be used to monitor battery pack 100 of FIG. 1, which may incorporate any or all of the features of FIGS. 1-6 as created by method 700 of FIG. 7, in accordance with some embodiments of this disclosure.

At 902, control circuitry may be used to monitor for data from sensors within a battery pack. For example, the control circuitry may be a collection of communication circuitry 808, monitoring circuitry 812, and reporting circuitry 816 of vehicle system 800. The battery pack may also be battery pack from 804 or battery pack 100 of FIG. 1, which may incorporate any or all of the features of FIGS. 1-6 as created by method 700 of FIG. 7, in accordance with some embodiments of this disclosure. At 904, data may be received by the control circuitry from a sensor within a battery pack. For example, the sensor may be one of a water sensor configured to detect standing water within the battery pack, a temperature sensor, a voltage sensor, or a pressure sensor. In some embodiments, the sensor may be sensor 806 of FIG. 8 providing data by communication path 810 to communication circuitry 808.

At 906, the value of the data received from the sensor may be compared to a predetermined threshold. In some embodiments, the comparison may occur at monitoring circuitry 812 from FIG. 8. For example, monitoring circuitry 812 may compare the one centimeter data value from sensor 806 to a threshold value, which may be 0.5 centimeters. If it is determined that the data value from the sensor does not exceed a threshold value (NO at 908), the system continues to monitor, using control circuitry, for data from battery pack sensors at 902. If it is determined that the data value from the sensor does exceed a threshold value (YES at 908), the system proceeds to provide a service warning to the user. Continuing from the water level example, monitoring circuitry 812 from FIG. 8 may determine the amount of water reported by sensor 806 within battery pack 804 exceeds the threshold and may send a notice to reporting circuitry 816 by communication path 818 that a service notice must be generated. In some embodiments, reporting circuitry 816 may cause a notification to be generated for vehicle 802 that service is required within battery pack 804 (e.g., a warning may be generated that water has entered batter pack 804 and service is required).

The systems and processes discussed above are intended to be illustrative and not limiting. One skilled in the art would appreciate that the actions of the processes discussed herein may be omitted, modified, combined, and/or rearranged, and any additional actions may be performed without departing from the scope of the invention. More generally, the above disclosure is meant to be exemplary and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

While some portions of this disclosure may refer to “convention” or examples, any such reference is merely to provide context to the instant disclosure and does not form any admission as to what constitutes the state of the art.

What is claimed is:

1. A battery pack, comprising:
an enclosure for at least one battery cell; and
one or more vents embedded in at least one wall of the enclosure, wherein each of the one or more vents are configured to reduce the excess pressure within the enclosure, and wherein the one or more vents includes at least:
one or more valves, including:
a vent plug valve configured to vent through the vent plug at a first flow rate;
an umbrella valve configured to vent through the umbrella valve at a second flow rate greater than the first flow rate; and
a deformable vent structure configured to permit a third flow rate through the deformable vent structure, the third flow rate greater than the second flow rate.

2. The battery pack of claim 1, wherein the vent plug valve is secured over a vent port.

3. The battery pack of claim 2, wherein the vent plug valve is axially adjustable relative to a surface of one of the walls, the vent plug installed into the one of the walls.

4. The battery pack of claim 3, wherein the vent plug is configured to vent at the first flow rate in response to a first threshold pressure within the battery pack.

5. The battery pack of claim 1, wherein the umbrella valve includes an umbrella seal.

6. The battery pack of claim 5, wherein the umbrella valve is configured to vent at the second flow rate in response to a second threshold pressure within the battery pack.

7. The battery pack of claim 6, wherein the umbrella valve further comprises a plurality of supports defining a plurality of vent channels extending through the umbrella plug.

8. The battery pack of claim 7, wherein the deformable vent structure includes the plurality of supports, the plurality of supports each defining a support thickness configured to melt in response to a predetermined quantity of heat vented through the umbrella plug, the predetermined quantity of heat associated with the third flow rate.

9. The battery pack of claim 5, wherein the umbrella valve includes the deformable structure at a center diameter of the umbrella seal.

10. The battery pack of claim 1, wherein the umbrella valve includes a membrane configured to prevent ingress of a liquid into the enclosure.

11. The battery pack of claim 1, wherein the deformable vent structure includes a seal configured to prevent fluid ingress through the deformable vent structure.

12. The battery pack of claim 11, wherein the deformable vent structure is configured to melt when exposed to a release of heat energy associated with the third flow rate.

13. The battery pack of claim 12, wherein the deformable vent structure is sized based on the release of heat energy associated with the third flow rate.

14. The battery pack of claim 1, wherein each of the one or more vents is embedded in a respective wall of the plurality of walls so as to not protrude beyond an outer surface of the respective wall.

15. The battery pack of claim 14, wherein each of the one or more vents has a threaded portion configured to mate with a threaded recess in the wall into which the one or more valves is installed, respectively.

16. The battery pack of claim 1, wherein each of the one or more valves has a radial seal configured to prevent liquid from passing a portion of each of the one or more valves that is exposed to the environment surrounding the battery pack.

17. The battery pack of claim 1, wherein the battery system further comprises control circuitry configured to process signals from one or more sensors positioned in the enclosure.

18. The battery pack of claim 17, wherein the one or more sensors comprises a water sensor configured to detect standing water within the enclosure, a temperature sensor, a voltage sensor, and a pressure sensor.

19. A vehicle system, comprising:
a plurality of walls defining at least in part an enclosure for a plurality of battery cells, the enclosure substantially sealed such that a thermal expansion causes excess pressure within the enclosure; and
one or more vents embedded in at least one wall of the enclosure, wherein each of the one or more vents are configured to reduce the excess pressure within the enclosure, and wherein the one or more vents includes at least:
one or more valves, including:
a vent plug valve configured to vent through the vent plug at a first flow rate;
an umbrella valve configured to vent through the umbrella valve at a second flow rate greater than the first flow rate; and
a deformable vent structure configured to permit a third flow rate through the deformable vent structure, the third flow rate greater than the second flow rate.

20. A method for venting a battery pack, the method comprising:
arranging a plurality of battery cells to provide electricity to a vehicle;
enclosing the plurality of battery cells with a plurality of walls, wherein the plurality of walls is substantially sealed such that a temperature increase causes excess pressure within an enclosure; and
embedding a plurality of venting structures in the plurality of walls, wherein each of the plurality of venting structures is configured to vent from the enclosure to reduce the excess pressure;
wherein a first vent type included in the plurality of venting structures is configured to vent from the enclosure at a first flow rate;
wherein a second vent type included in the plurality of venting structures is configured to vent from the enclosure at a second flow rate, the second flow rate greater than the first flow rate; and
wherein a third vent type included in the plurality of venting structures is configured to vent from the enclosure at a third flow rate, the third flow rate greater than the second flow rate.
